(19) United States
(12) Patent Application Publication
(10) Pub. No.: US 2021/0199954 A1
(43) Pub. Date: Jul. 1, 2021

(54) Monitoring Apparatus

(71) Applicant: Mitsubishi Electric Corporation, Chiyoda-ku, Tokyo (JP)

(72) Inventor: Sumitoshi KAWASAKI, Chiyoda-ku, Tokyo (JP)

(73) Assignee: Mitsubishi Electric Corporation, Chiyoda-ku, Tokyo (JP)

(21) Appl. No.: 16/761,847

(22) PCT Filed: Nov. 27, 2017
(86) PCT No.: PCT/JP2017/042367

§ 371 Date: May 6, 2020

(51) Int. Cl. G02B 27/00; G02B 27/28; H04N 7/18; H04N 5/225; H04N 5/235

(52) U.S. Cl. CPC G02B 27/0018; G02B 27/281; H04N 7/18; H04N 5/2351; H04N 5/2254; H04N 5/2256; H04N 5/22521

(57) ABSTRACT

A monitoring apparatus has a rotatable first polarization filter and a rotational drive circuit in an image pick-up element and has a second polarization filter and a rotational drive circuit on a light emission side of a near infrared LED. An angle of a polarization axis of the polarization filter is each independently adjustable. In order to lessen influence by sunlight or scattering, the polarization filter on a lens side is rotated to minimize output from a light quantity sensor while the near infrared LED is turned off. Optical noise is thus lowered. The polarization filter on an LED side is rotated to maximize contrast. Thus, a virtual image of a camera image due to reflection and scattering of light is lessened, quality of an image signal is improved, and a stable image signal is obtained. Thus, erroneous sensing in image processing can be lessened.

### TECHNICAL FIELD

The disclosure relates to a monitoring apparatus and particularly to a monitoring apparatus configured to accurately pick up an image of an object to be recognized by preventing in an image, a virtual image caused by reflection or scattering of light.

### BACKGROUND ART

A monitoring apparatus senses doze or inattentiveness of a driver by using a near infrared image pick-up apparatus and image processing. It has been known in connection with a near infrared image pick-up apparatus that a virtual image is created in a camera image due to reflection of light by presence of a glossy surface of a subject or presence of glass, which adversely affects image processing.

A technique disclosed in Japanese Patent Laying-Open No. 2008-61211 (PTL 1) addresses a virtual image by providing a polarizing plate between near infrared rays and a subject and between the subject and a camera for preventing the virtual image.

### CITATION LIST

### Patent Literature

PTL 1: Japanese Patent Laying-Open No. 2008-61211

### SUMMARY OF INVENTION

### Technical Problem

According to a configuration described in Japanese Patent Laying-Open No. 2008-61211, two near infrared polarizing plates intersect with each other at a right angle. The right angle, however, may be displaced due to variation in manufacturing of the polarizing plates or variation in accuracy and errors in assembly at the time of manufacturing. When the right angle is displaced, a component of a virtual image resulting from reflection of lighting to the glossy surface tends to appear in an image.

The disclosure was made to solve the problem as above and an object thereof is to provide a monitoring apparatus capable of obtaining a stable result of monitoring.

### Solution to Problem

The present disclosure relates to a monitoring apparatus. The monitoring apparatus includes a light source, a first polarization filter arranged in a light reception path of the light source, the first polarization filter allowing passage of linear polarized light therethrough, a first apparatus configured to vary a direction of a polarization axis of the first polarization filter, an image pick-up element, a second polarization filter arranged in a light projection path of the image pick-up element, the second polarization filter allowing passage of linear polarized light therethrough, and a second apparatus configured to vary a direction of a polarization axis of the second polarization filter.

### Advantageous Effects of Invention

According to the disclosure, the directions of the polarization axes of the two polarization filters can be varied and hence errors in a relative angle due to errors in manufacturing of the polarization filters or accuracy in assembly at the time of manufacturing can be adjusted. Therefore, lowering in signal level for image processing can be suppressed and a stable result of monitoring is obtained.

### BRIEF DESCRIPTION OF DRAWINGS

FIG. 1 is a diagram showing a state that a monitoring apparatus is provided in a vehicle.

FIG. 2 is a block diagram showing a configuration of the monitoring apparatus.

FIG. 3 is a conceptual diagram for illustrating displacement of a polarization axis.

FIG. 4 is a flowchart for illustrating processing performed by a controller of the monitoring apparatus in a first embodiment.

FIG. 5 is a flowchart for illustrating processing performed by the controller of the monitoring apparatus in a second embodiment.

FIG. 6 is a flowchart for illustrating processing performed by the controller of the monitoring apparatus in a third embodiment.

### DESCRIPTION OF EMBODIMENTS

Embodiments of the present disclosure will be described below in detail with reference to the drawings. The same or corresponding elements in the drawings below have the same reference characters allotted. Forms of constituent elements represented in the full text of the specification are merely by way of example and limitation thereto is not intended.

[Arrangement of Monitoring Apparatus]

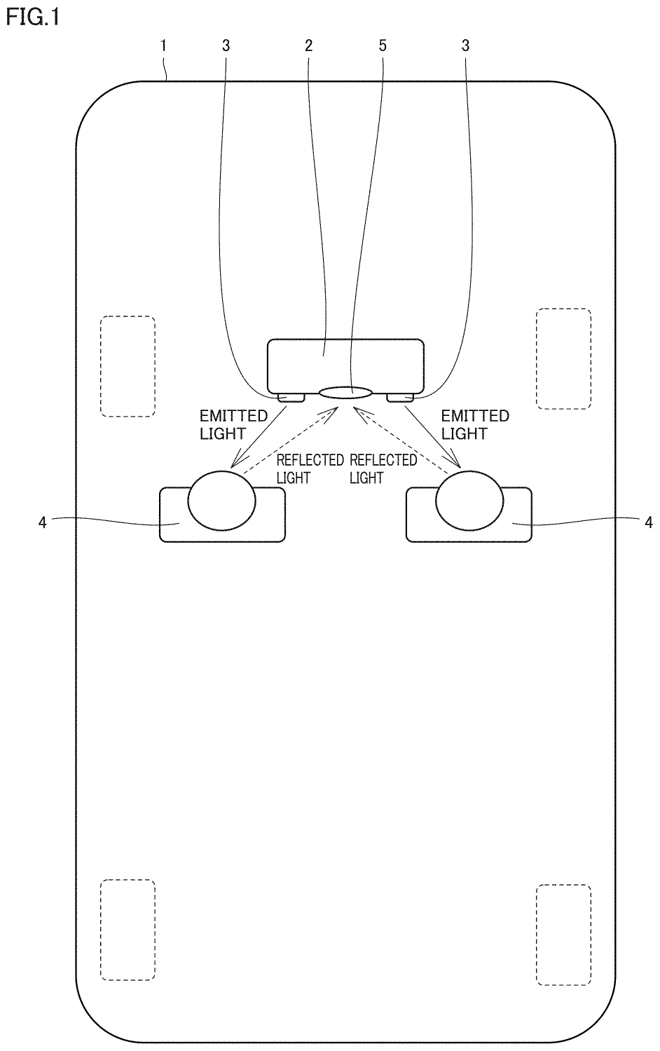

FIG. 1 is a diagram showing a state that a monitoring apparatus is provided in a vehicle. A monitoring apparatus 2 described in an embodiment below emits light to a subject (a driver and/or a passenger) 4 from a light emitter 3 and picks up an image through a camera lens 5 as shown in FIG. 1.

Monitoring apparatus 2 includes independently rotatably controllable polarization filters on respective sides of light emitter 3 and camera lens 5. Monitoring apparatus 2 can suppress entry of unnecessary light into an image pick-up element by rotating the polarization filter on a camera side so as to minimize output from a light quantity sensor with light emitter 3 being turned off. In addition, the monitoring apparatus can lessen a virtual image by rotating the polarization filter on a light emitter side so as to maximize contrast of an image with light emitter 3 being turned on. An image processing signal with which a subject can be recognized can thus be obtained.

According to monitoring apparatus 2 in the present embodiment, S/N of a signal for image processing can be improved and a stable result of calculation in image processing can be obtained by suppressing lowering in signal level for image processing due to accuracy in assembly of the polarization filter at the time of manufacturing or variation in manufacturing between individual polarization filters and by lessening influence by unnecessary light from an ambient environment.

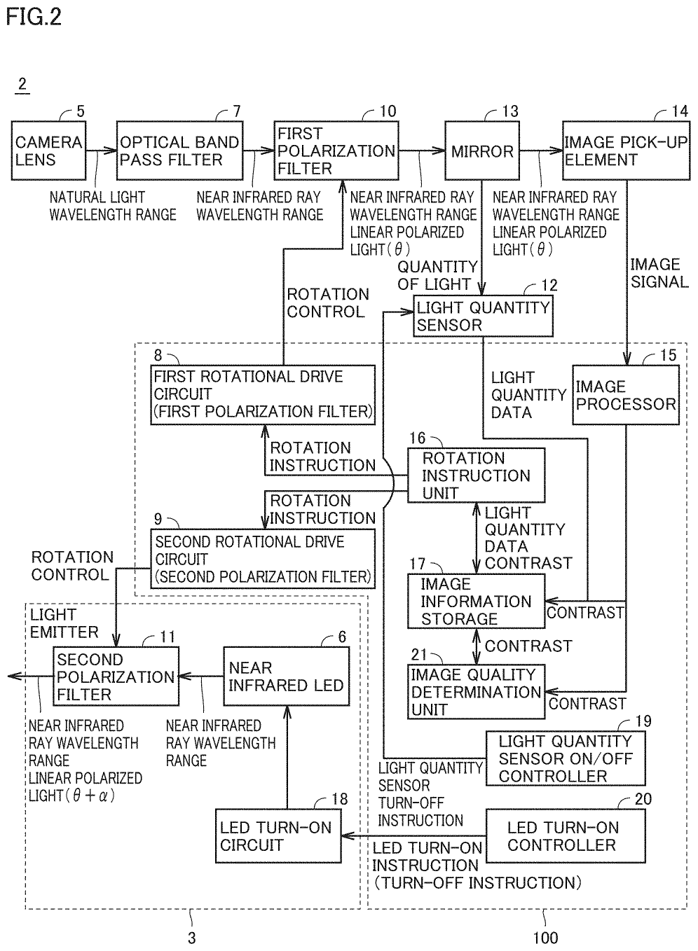

FIG. 2 is a block diagram showing a configuration of the monitoring apparatus. In FIG. 2, monitoring apparatus 2 includes light emitter 3, camera lens 5, an optical band pass filter 7, a first polarization filter 10, a light quantity sensor 12, a mirror 13, an image pick-up element 14, and a controller 100.

Light emitter 3 includes a near infrared LED 6 serving as a light source, an LED turn-on circuit 18, and a second polarization filter 11. Near infrared LEDs 6 may be arranged around the entire circumference of camera lens 5 or on left and right sides of camera lens 5.

Controller 100 includes a first rotational drive circuit 8, a second rotational drive circuit 9, an image processor 15, a rotation instruction unit 16, an image information storage 17, an image quality determination unit 21, a light quantity sensor ON/OFF controller 19, and an LED turn-on controller 20.

First polarization filter 10 is arranged in a light reception path of image pick-up element 14 and allows passage of linear polarized light therethrough. First rotational drive circuit 8 varies a direction of a polarization axis of first polarization filter 10. Second polarization filter 11 is arranged in a light projection path of near infrared LED 6 and allows passage of linear polarized light therethrough. Second rotational drive circuit 9 varies a direction of a polarization axis of second polarization filter 11.

First rotational drive circuit 8 is configured to vary an angle of rotation around a light reception axis of first polarization filter 10. Second rotational drive circuit 9 is configured to vary an angle of rotation around a light projection axis of second polarization filter 11.

Light quantity sensor 12 detects a quantity of light that passes through first polarization filter 10 and enters image pick-up element 14. Rotation instruction unit 16 controls an angle of rotation of second polarization filter 11 and an angle of rotation of first polarization filter 10 by means of second rotational drive circuit 9 and first rotational drive circuit 8, based on a detection value from light quantity sensor 12.

Image processor 15 calculates contrast of an image picked up by image pick-up element 14. Rotation instruction unit 16 controls the angle of rotation of first polarization filter 10 and the angle of rotation of second polarization filter 11 by means of first rotational drive circuit 8 and second rotational drive circuit 9, based on a detection value from light quantity sensor 12 and contrast calculated by image processor 15.

An image of subject 4 irradiated by light emitter 3 is input to monitoring apparatus 2 through camera lens 5. Light representing the image at this time contains a component of linear polarized light in a wavelength range of near infrared rays and components other than that. The components other than linear polarized light in the wavelength range of near infrared rays become a noise signal in image processing. Therefore, by passage of light through optical band pass filter 7 for removing noise, transmitted light is limited to light in a band identical to a wavelength of light emitter 3, and only the components of linear polarized light are allowed to pass through first polarization filter 10 to reach the mirror.

A quantity of light representing the image consisting of the components of linear polarized light in the wavelength range of near infrared rays is distributed to image pick-up element 14 and light quantity sensor 12 by mirror 13. Light quantity sensor 12 generates light quantity data. The image is transmitted from image pick-up element 14 to image processor 15 as an image signal and image processor 15 calculates contrast of the image.

When light that has passed through second polarization filter 11 and goes out as linear polarized light experiences ideal specular reflection at a water surface or glass, it is reflected with polarization of incident light being maintained. By cutting off this light with the polarization filter of which polarization axis has been varied by 90°, gloss such as reflection can be eliminated. Since diffused reflection occurs at the surface of an object to be observed, reflected light includes a component of which polarization axis is rotated by 90° and an image is obtained by light that has passed through the polarization filter. The polarization axis of the polarization filter, however, may be displaced.

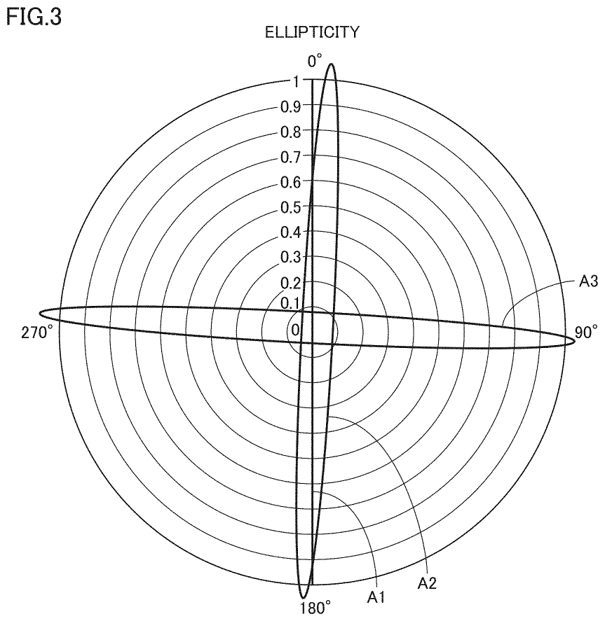

FIG. 3 is a conceptual diagram for illustrating displacement of the polarization axis. In FIG. 3, intensity of light through a linear polarization plate and an angle (a structural angle) are plotted.

A characteristic A1 shown with a straight line represents an ideal characteristic of a polarization filter. In contrast, a characteristic A2 of real polarization filter 10 does not exhibit linear polarization but other polarization components are also mixed therein as shown with an ellipse, which means that a polarization axis may also be displaced due to errors in manufacturing or errors in assembly. A characteristic A3 of polarization filter 11 orthogonal thereto does not exhibit linear polarization either and other polarization components are also mixed therein as shown with an ellipse, which means that a polarization axis may also be displaced due to errors in manufacturing or errors in assembly.

Therefore, in the present embodiment, first rotational drive circuit 8 and second rotational drive circuit 9 are provided such that the angle of rotation of first polarization filter 10 and the angle of rotation of second polarization filter 11 can independently be adjusted.

### First Embodiment

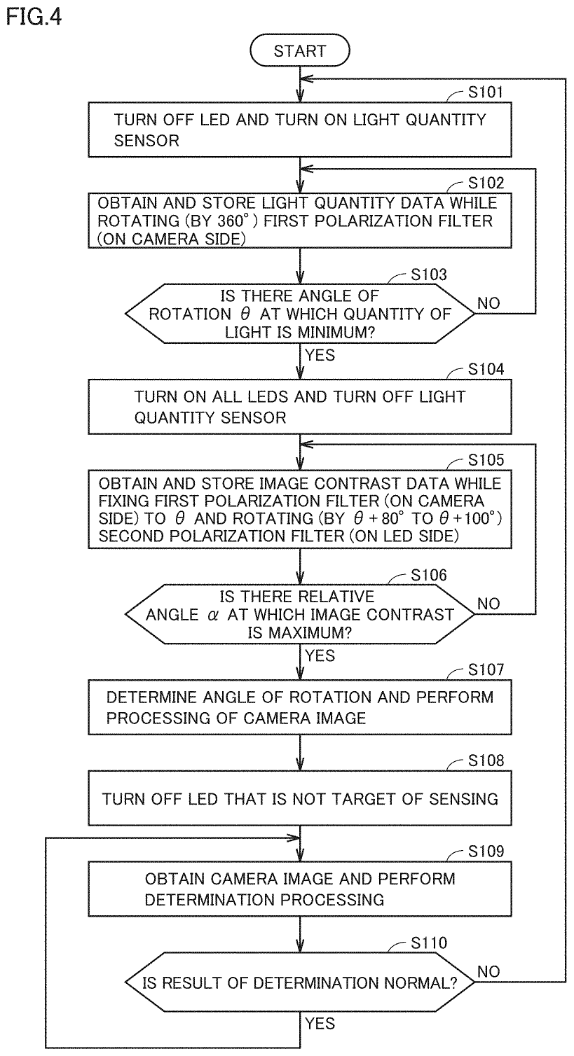

FIG. 4 is a flowchart for illustrating processing performed by the controller of the monitoring apparatus in a first embodiment. Controller 100 in FIG. 2 performs processing for removing a linear polarization component in a wavelength range of near infrared rays, of a virtual image created by reflection or scattering of sunlight in accordance with the flowchart in FIG. 4.

In steps S101 to S103, controller 100 determines an angle of rotation θ of polarization filter 10 on the camera side so as to minimize a quantity of light that enters the camera by reflection or scattering of sunlight initially with the LED being turned off. Thereafter, in steps S104 to S107, a relative angle α between two polarization filters is finely adjusted to obtain an image high in contrast with all LEDs being turned on.

Initially, in order to set polarization filter 10 on the camera side, controller 100 turns on the light quantity sensor in step S101. Then, in step S102, controller 100 controls rotational drive circuit 8 to rotate first polarization filter 10 by 360° from the origin of angle in 1° increments and has image information storage 17 store light quantity data at each angle.

In step S103, rotation instruction unit 16 finds an angle of rotation at which a quantity of light is minimized based on data stored in image information storage 17. When angle of rotation θ at which the quantity of light is minimized is obtained (YES in S103), the rotation instruction unit issues an instruction about angle of rotation θ to rotational drive circuit 8 to set the angle of rotation of first polarization filter 10 to θ. When angle of rotation θ at which the quantity of light is minimized is not found (NO in S103), the process returns to step S102.

In an environment around a location where the monitoring apparatus is provided, a polarization angle of light reflection or scattering is not unique, and in an ambient environment where intensity of unnecessary light toward the camera is maximized, noise of a signal for image processing disadvantageously increases. In the first embodiment, by performing processing in steps S101 to S103 with LED 6 being turned off, rotation instruction unit 16 determines the direction of the polarization axis of first polarization filter 10 so as to minimize a quantity of unnecessary light that enters image pick-up element 14. Since influence by a light emitter of another apparatus identical in type in a vehicle or influence by light inside and outside vehicle 1 can thus be less likely also at night, an effect of removing a virtual image is obtained.

In succession, in order to set the angle of rotation of polarization filter 11 on the light emitter side, in step S104, LED turn-on controller 20 gives an LED turn-on instruction to LED turn-on circuit 18 and light quantity sensor ON/OFF controller 19 transmits a light quantity sensor OFF instruction to light quantity sensor 12.

In step S105, controller 100 sets the angle of rotation of first polarization filter 10 (on the camera side) to angle θ obtained in step S103. Then, second polarization filter 11 (on the LED side) is rotated in 1° increments within a range of angles from θ+80° to θ+100° (that is, θ+90°±10°) and data on contrast at each angle is stored in image information storage 17. Data on contrast is obtained by contrast calculation by image processor 15, of an image signal obtained from image pick-up element 14.

In step S106, rotation instruction unit 106 finds the angle of rotation at which contrast is maximized, based on data stored in image information storage 17. θ represents an angle of rotation of first polarization filter 10 and a represents a relative angle between first polarization filter 10 and the second polarization filter. When an angle of rotation θ+α at which contrast is maximized is obtained (YES in S106), the rotation instruction unit issues an instruction about angle of rotation θ+α to rotational drive circuit 9 to set the angle of rotation of second polarization filter 11 to θ+α. When the angle of rotation (θ+α) at which contrast is maximized is not found (NO in S106), the process returns to step S105. By thus determining relative angle α, errors in manufacturing of the filter or errors in assembly of the filter are corrected and a difference in angle between the polarization axes of first polarization filter 10 and second polarization filter 11 is correctly set to 90°.

When angle of rotation θ and relative angle α are determined, controller 100 performs desired image processing by means of image processor 15 in step S107 and turns off an LED that is not a target of sensing in step S108. For example, when vehicle 1 is a right-hand drive vehicle and there is no subject in a passenger seat, light emitter 3 on a passenger seat side is turned off.

In step S109, image processor 15 calculates contrast of the image signal obtained from image pick-up element 14, and image quality determination unit 21 makes determination based on a threshold value for contrast determination set in advance. When contrast is equal to or lower than the threshold value (NO in S110), the process returns to S101. When contrast is higher than the threshold value (YES in S110), processing in step S109 is repeatedly performed and an image obtained by the camera is used for a monitoring purpose.

As described above, the monitoring apparatus according to the first embodiment includes a polarization filter and rotation control in both of light emitter 3 and image pick-up element 14. By rotating polarization filter 10 on the camera side to minimize output from light quantity sensor 12 while the LED is turned off, entry of unnecessary light into image pick-up element 14 is suppressed. By rotating polarization filter 11 on light emitter 3 side so as to maximize contrast of the image while the LED is turned on, a processing signal of an image in which a virtual image is lessened can be obtained.

By thus lessening influence by unnecessary light from an ambient environment and correcting displacement in angle caused by errors in manufacturing of the filter or errors in assembly of the filter, S/N of a signal for image processing can be improved and a stable result of calculation in image processing can be obtained. Since image processing for addressing a virtual image does not have to be added, load imposed by calculation in image processing can be lessened.

### Second Embodiment

Though a method of suppressing a virtual image by using light quantity sensor 12 is shown in the first embodiment, limitation thereto is not intended. A virtual image may also be suppressed only based on contrast of an image without using a light quantity sensor, as in a second embodiment described below.

In the second embodiment, relative angle a between first polarization filter 10 and second polarization filter 11 is initially set to 90°, angle of rotation θ at which a minimum value of unnecessary light is achieved is searched for, and relative angle α is finely adjusted based on contrast of an image after angle θ is determined. In the second embodiment, an effect of decrease in time period until completion of adjustment of an angle and an effect of obviating mirror 13 and light quantity sensor 12 are obtained.

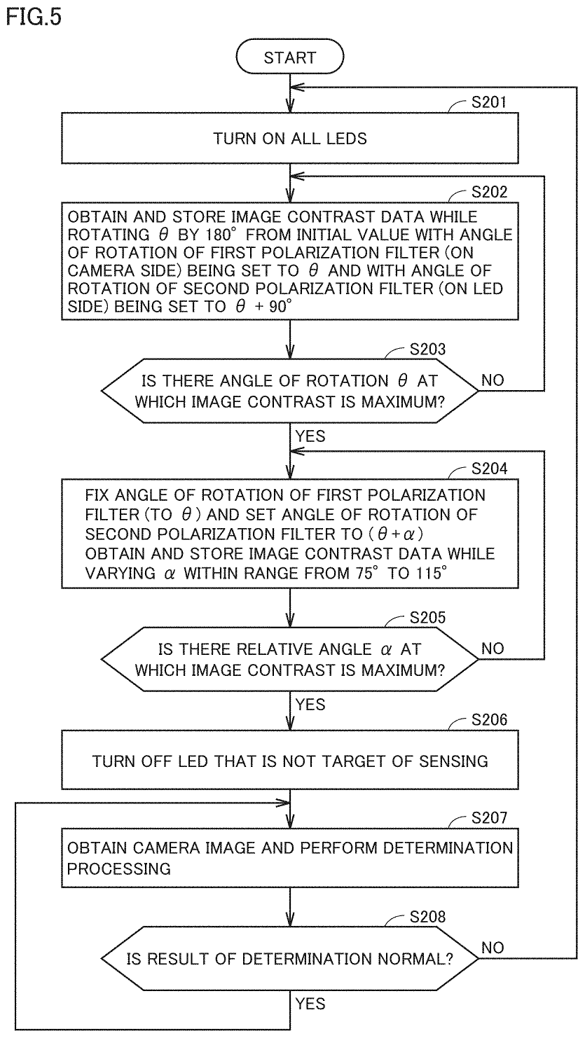

FIG. 5 is a flowchart for illustrating processing performed by the controller of the monitoring apparatus in the second embodiment.

Referring to FIGS. 2 and 5, in step S201, LED turn-on controller 20 of controller 100 turns on all near infrared LEDs 6 of light emitter 3.

In succession, in step S202, image contrast data is obtained and stored while the polarization filters are rotated by 180° in 1° increments from an initial value θ0 of angle of rotation θ with the angle of rotation of first polarization filter 10 (on the camera side) being set to θ and with the angle of rotation of second polarization filter 11 (on the LED side) being set to θ+90°.

Angle of rotation θ of first polarization filter 10 is varied from initial value θ0 to (θ0+180°) in 1° increments. Second polarization filter 11 is rotated as following first polarization filter 10 with relative angle α=90° relative to the first polarization filter being maintained.

Image processor 15 receives an image signal obtained by image pick-up element 14, calculates contrast, and has image information storage 17 store contrast data. Contrast data corresponding to each angle of rotation θ is thus stored.

In step S203, rotation instruction unit 16 calculates angle of rotation θ at which contrast is maximized based on data stored in image information storage 17. When angle of rotation θ at which contrast of the image is maximized is not obtained (NO in S203), processing in step S202 is performed again.

When angle of rotation θ at which contrast of the image is maximized is obtained (YES in S203), rotation instruction unit 16 instructs first rotational drive circuit 8 to fix angle of rotation θ indicated by the result of calculation and indicates an angle of rotation (θ+α) to second rotational drive circuit 9 in step S204. At this time, relative angle α is varied in 1° increments within a range from 75° to 115°, that is, a range of 90°±25°.

Image processor 15 receives an image signal obtained by image pick-up element 14, calculates contrast, and has image information storage 17 store contrast data. Contrast data corresponding to each relative angle α is thus stored.

In succession, in step S205, rotation instruction unit 16 calculates relative angle α at which contrast is maximized based on data stored in image information storage 17. When relative angle α at which contrast of the image is maximized is not obtained (NO in S205), processing in step S204 is performed again.

When relative angle α at which contrast of the image is maximized is obtained (YES in S205), rotation instruction unit 16 instructs first rotational drive circuit 8 to fix angle of rotation θ indicated by the result of calculation and instructs second rotational drive circuit 9 to fix angle of rotation (θ+α) indicated by the result of calculation.

When angle of rotation θ and relative angle α are determined, an LED which is not a target of sensing is turned off in step S206. For example, when vehicle 1 is a right-hand drive vehicle and there is no subject in a left passenger seat, light emitter 3 on the passenger seat side is turned off.

In step S207, image processor 15 performs contrast calculation of the image signal obtained by image pick-up element 14 and image quality determination unit 21 makes determination based on a threshold value for contrast determination set in advance. When contrast is equal to or lower than the threshold value (NO in S208), the process returns to S201. When contrast is higher than the threshold value (YES in S208), processing in step S207 is repeatedly performed and an image obtained by the camera is used for a monitoring purpose.

### Third Embodiment

Though a method of suppressing a virtual image is shown in the first and second embodiments, limitation thereto is not intended. A specific approach to decrease in time period for adjustment of an angle will be described in a third embodiment.

A normal near infrared LED emits light without polarization. LEDs are individually different in angle at which intensity of light that can pass through a polarization filter is maximized. Therefore, depending on accuracy in assembly at the time of manufacturing and a lot of LEDs, intensity of light that can pass through the polarization filter is disadvantageously lowered and a signal level for image processing is lowered. In order to solve this problem, in the third embodiment, a relative angle between first polarization filter 10 and second polarization filter 11 is set to 0°, an angle of rotation β at which a quantity of light in accordance with a characteristic of an individual LED is maximized with the LED being turned on is found, and thereafter a minimum value of unnecessary light is finely adjusted by using first polarization filter 10 on the camera side. Though an image high in luminance due to reflection or the like is cut off by setting an angle of rotation of first polarization filter 10 on the camera side to an optimal value, a quantity of light diffusely reflected at a surface of a subject to be monitored is not much varied in spite of change in angle of rotation of first polarization filter 10. Therefore, minimum unnecessary light is achieved based on an angle of rotation of the first polarization filter at which a quantity of light is minimized.

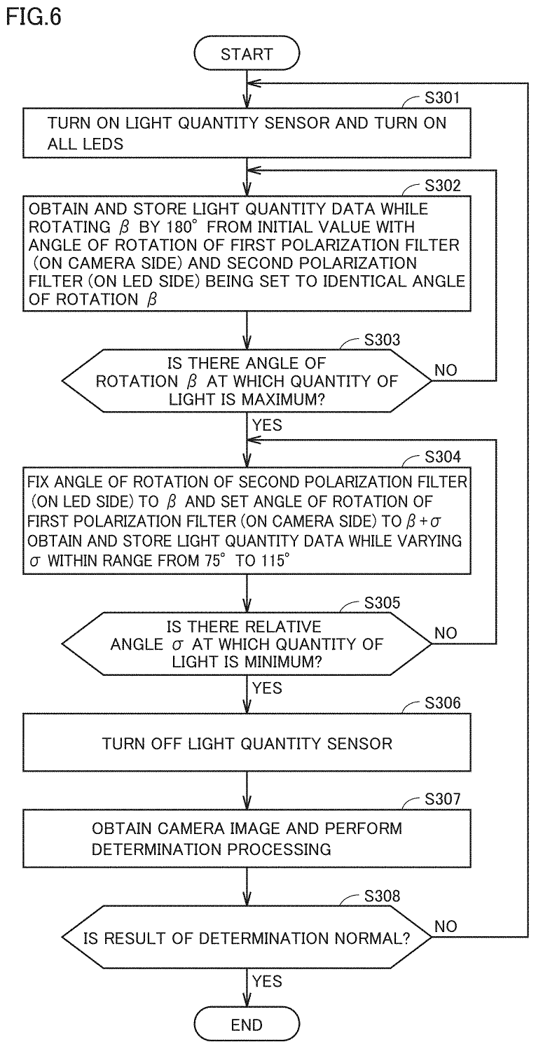

FIG. 6 is a flowchart for illustrating processing performed by the controller of the monitoring apparatus in the third embodiment.

Referring to FIGS. 2 and 6, controller 100 turns on light quantity sensor 12 and turns on all near infrared LEDs 6 of light emitter 3 in step S301.

In succession, in step S302, light quantity data is obtained and stored while the polarization filters are rotated by 180° in 1° increments from initial value θ0 of angle of rotation β with the angle of rotation of first polarization filter 10 (on the camera side) being set to β and with the angle of rotation of second polarization filter 11 (on the LED side) also being set to β.

Angle of rotation β of second polarization filter 11 is varied from initial value θ0 to (θ0+180° in 1° increments. First polarization filter 10 is rotated as following second polarization filter 11 with the angle relative to second polarization filter 11 being maintained at 0°.

Light quantity data obtained by light quantity sensor 12 is stored in image information storage 17. Light quantity data corresponding to each angle of rotation is thus stored.

In step S303, rotation instruction unit 16 calculates angle of rotation β at which the quantity of light is maximized based on data stored in image information storage 17. When angle of rotation β at which the quantity of light is maximized is not obtained (NO in S303), processing in step S302 is performed again.

In the third embodiment, by performing processing in steps S301 to S303, rotation instruction unit 16 determines the direction of the polarization axis of second polarization filter 11 so as to maximize the quantity of light that enters image pick-up element 14 with the light source being turned on.

When angle of rotation 13 at which the quantity of light is maximized is obtained (YES in S303), rotation instruction unit 16 instructs second rotational drive circuit 9 to fix angle of rotation β indicated by the result of calculation and indicates an angle of rotation (β+σ) to first rotational drive circuit 8 in step S304. β represents the angle of rotation of second polarization filter 11 and a represents a relative angle between first polarization filter 10 and the second polarization filter. At this time, relative angle σ is varied in 1° increments within a range from 75° to 115°, that is, a range of 90°±25°.

Light quantity data obtained by light quantity sensor 12 is stored in image information storage 17. Light quantity data corresponding to each relative angle σ is thus stored.

In step S305, rotation instruction unit 16 calculates relative angle σ at which the quantity of light is minimized based on data stored in image information storage 17. When relative angle σ at which the quantity of light is minimized is not obtained (NO in S305), processing in step S304 is performed again.

When relative angle σ at which the quantity of light is minimized is obtained (YES in S305), an instruction to fix relative angle σ to a value that allows a minimum quantity of light is sent to first rotational drive circuit 8 in step S304. In step S306, controller 100 turns off light quantity sensor 12.

When angle of rotation β and relative angle σ are determined, in step S307, image processor 15 performs contrast calculation of the image signal obtained by image pick-up element 14 and image quality determination unit 21 makes determination based on a threshold value for contrast determination set in advance. When contrast is equal to or lower than a threshold value (NO in S308), the process returns to S301. When contrast is higher than the threshold value (YES in S308), processing for adjusting an angle of the polarization filter is completed and an image subsequently obtained by the camera is used for a monitoring purpose.

Though light quantity data is obtained and relative angle σ at which the quantity of light is minimized is found in steps S304 and S305, relative angle σ may be determined so as to maximize image contrast as in steps S204 and S205 in the second embodiment.

According to the third embodiment, a maximum quantity of polarized light obtained by light emitter 3 can be emitted to subject 4 and a virtual image created by reflection at a glossy surface can be suppressed. Therefore, an image satisfactory as a monitor image can be obtained.

It should be understood that the embodiments disclosed herein are illustrative and non-restrictive in every respect. The scope of the present disclosure is defined by the terms of the claims rather than the description of the embodiments above and is intended to include any modifications within the scope and meaning equivalent to the terms of the claims.

### REFERENCE SIGNS LIST

1 vehicle; 2 monitoring apparatus; 3 light emitter; 4 subject; 5 camera lens; 7 optical band pass filter; 8, 9 rotational drive circuit; 10, 11 polarization filter; 12 light quantity sensor; 13 mirror; 14 image pick-up element; 15 image processor; 16 rotation instruction unit; 17 image information storage; 18 LED turn-on circuit; 19 light quantity sensor ON/OFF controller; 20 turn-on controller; 21 image quality determination unit; 100 controller

1. A monitoring apparatus comprising:
an image pick-up element;
a first polarization filter arranged in a light reception path of the image pick-up element, the first polarization filter allowing passage of linear polarized light;
a first apparatus to vary a direction of a polarization axis of the first polarization filter;
a light source;
a second polarization filter arranged in a light projection path of the light source, the second polarization filter allowing passage of linear polarized light; and
a second apparatus to vary a direction of a polarization axis of the second polarization filter.

2. The monitoring apparatus according to claim 1, wherein
the first apparatus is configured to vary an angle of rotation around a light reception axis of the first polarization filter,
the second apparatus is configured to vary an angle of rotation around a light projection axis of the second polarization filter, and
the monitoring apparatus further comprises:
a light quantity sensor to detect a quantity of light that passes through the first polarization filter and enters the image pick-up element; and
a rotation instruction unit to control the angle of rotation of the first polarization filter and the angle of rotation of the second polarization filter with the first apparatus and the second apparatus, based on a detection value from the light quantity sensor.

3. The monitoring apparatus according to claim 2, wherein
the rotation instruction unit determines the direction of the polarization axis of the first polarization filter so as to minimize the quantity of light that enters the image pick-up element with the light source being turned off.

4. The monitoring apparatus according to claim 2, wherein
the rotation instruction unit determines the direction of the polarization axis of the second polarization filter so as to maximize the quantity of light that enters the image pick-up element with the light source being turned on.

5. The monitoring apparatus according to claim 2, further comprising an image processor to calculate contrast of an image picked up by the image pick-up element, wherein
the rotation instruction unit controls the angle of rotation of the first polarization filter and the angle of rotation of the second polarization filter with the first apparatus and the second apparatus, based on a detection value from the light quantity sensor and the contrast calculated by the image processor.

6. The monitoring apparatus according to claim 5, wherein
the rotation instruction unit determines the direction of the polarization axis of the first polarization filter so as to minimize the quantity of light that enters the image pick-up element with the light source being turned off.

7. The monitoring apparatus according to claim 5, wherein
the rotation instruction unit determines the direction of the polarization axis of the second polarization filter so as to maximize the quantity of light that enters the image pick-up element with the light source being turned on.

8. The monitoring apparatus according to claim 1, wherein
the first apparatus is configured to vary an angle of rotation around a light projection axis of the first polarization filter,
the second apparatus is configured to vary an angle of rotation around a light reception axis of the second polarization filter, and
the monitoring apparatus further comprises:
an image processor to calculate contrast of an image picked up by the image pick-up element; and
a rotation instruction unit to control the angle of rotation of the first polarization filter and the angle of rotation of the second polarization filter with the first apparatus and the second apparatus, based on the contrast calculated by the image processor.

9. The monitoring apparatus according to claim 8, wherein
the rotation instruction unit determines the angle of rotation of the first polarization filter and the angle of rotation of the second polarization filter so as to maximize the contrast.

10. A monitoring apparatus comprising:
an image pick-up element;
a first polarization filter arranged in a light reception path of the image pick-up element, the first polarization filter allowing passage of linear polarized light;
a first apparatus to vary a direction of a polarization axis of the first polarization filter;
a light source;
a second polarization filter arranged in a light projection path of the light source, the second polarization filter allowing passage of linear polarized light; and
a second apparatus to vary a direction of a polarization axis of the second polarization filter, wherein
the first apparatus is configured to vary an angle of rotation around a light reception axis of the first polarization filter,
the second apparatus is configured to vary an angle of rotation around a light projection axis of the second polarization filter, and
the monitoring apparatus further comprises:
a light quantity sensor to detect a quantity of light that passes through the first polarization filter and enters the image pick-up element; and
a rotation instruction unit to control the angle of rotation of the first polarization filter and the angle of rotation of the second polarization filter with the first apparatus and the second apparatus, based on a detection value from the light quantity sensor.

11. The monitoring apparatus according to claim 10, wherein
the rotation instruction unit determines the direction of the polarization axis of the first polarization filter so as to minimize the quantity of light that enters the image pick-up element with the light source being turned off.

12. The monitoring apparatus according to claim 10, wherein
the rotation instruction unit determines the direction of the polarization axis of the second polarization filter so as to maximize the quantity of light that enters the image pick-up element with the light source being turned on.

13. The monitoring apparatus according to claim 10, further comprising an image processor to calculate contrast of an image picked up by the image pick-up element, wherein
the rotation instruction unit controls the angle of rotation of the first polarization filter and the angle of rotation of the second polarization filter with the first apparatus and the second apparatus, based on a detection value from the light quantity sensor and the contrast calculated by the image processor.

14. The monitoring apparatus according to claim 13, wherein
the rotation instruction unit determines the direction of the polarization axis of the first polarization filter so as to minimize the quantity of light that enters the image pick-up element with the light source being turned off.

15. The monitoring apparatus according to claim 13, wherein
the rotation instruction unit determines the direction of the polarization axis of the second polarization filter so as to maximize the quantity of light that enters the image pick-up element with the light source being turned on.
